(19) United States
(12) Patent Application Publication
(10) Pub. No.: US 2026/0215466 A1
(43) Pub. Date: Jul. 30, 2026

(54) GELLING COMPOSITION AND PROCESS

(71) Applicant: INTERNATIONAL N&H DENMARK APS, Kongens Lyngby (DE)

(72) Inventors: Jesper M. Schmidt, Kongens Lyngby (DE); Helge H. Nielsen, Kongens Lyngby (DE)

(21) Appl. No.: 19/142,999

(22) PCT Filed: Jan. 25, 2024
(86) PCT No.: PCT/EP2024/051755

§ 371 Date: Jun. 25, 2025

(30) Foreign Application Priority Data
Jan. 26, 2023 (EP) 23153403.3

(51) Int. Cl. A23L 29/231; A23J 3/22; A23L 21/10; A23L 29/00; A23L 29/256

(52) U.S. Cl. CPC A23L 29/231; A23J 3/227; A23L 21/10; A23L 29/035; A23L 29/256

(57) ABSTRACT

The present invention relates to a gelling composition to produce a food product. The composition comprises a mixture of plant-based protein and/or animal-based proteins, pectin sources and/or salts of alginate and a calcium source. In addition, the invention also relates to food products containing the composition and the process of producing the same.

### FIELD OF THE INVENTION

The present invention relates to a gelling composition to produce a food product. The composition comprises a mixture of ingredients to achieve the desirable texture of the food product. The invention discloses the use of a gelling product under cold conditions without any heating steps useful for several existing food production processes, where cold conditions are preferable. In addition, the invention also relates to plant-based food products containing the composition and the process of producing the same.

### BACKGROUND OF THE INVENTION

Plant proteins have the capability of gelling by heating, like salt- and phosphate-soluble meat proteins do. However, some plant protein gels based on abundantly available vegetable proteins, like soy or pea isolates, which have already been heat denatured in the protein production process, are not so strong as the meat protein gels. In vegetarian meat alternative products egg-white is therefore often used to strengthen the gel, but that is not an option in vegan meat alternative products.

Methyl cellulose is a preferred hydrocolloid in vegan meat alternative products, as it provides the desired texture in hot consumed products. However, when cooled down the methyl cellulose gel will melt, i.e. vegan meat alternative products would often also need to contain vegan acceptable ingredients providing the desired texture in the cold vegan meat alternative product, like for example carrageenan and konjac.

However, there has also for some time been a trend or a desire within the meat alternative solutions, to avoid the use of methyl cellulose (MC) (E461) as a food additive, because of the pressure for having clean or cleaner label food products avoiding ingredients having “chemical” names unfamiliar to many consumers.

A new cleaner label process based on just one hydrocolloid, alginate, and encapsulated calcium lactate providing both hot and cold texture was described in WO2022074217. As mentioned in the above disclosure, alternatives to methyl cellulose, which also provides heat stable gels, includes pectin sources. However, pectin sources are normally not suitable for cold production processes, since traditionally the pectin sources require a hot pre-solubilization of the pectin. Furthermore, pectins exhibit limited stability at neutral pH, and therefore pectins are widely used in gelled food products at pH below 4.5.

We have surprisingly found that a complete cold process (5° C.) applying pectin sources and/or fiber ingredients rich in pectins in combination with methylesterases produce stronger gels than obtainable with the use of alginates, when used under the cold conditions as described in the above patent application suitable for food production. Furthermore, surprisingly these strong pectin gels are obtained at pH closer to neutral pH and not necessarily below pH 4.5 typical for standard LM pectin applications. However, the gelling process is also effective below pH 4.5.

The invention provides a solution to meat alternatives, which is entirely vegan and without methylcellulose (MC) and which has an acceptable structure, produced at low temperatures through the entire process. This provides a process more suitable for food production using a typical meat-plant equipment set-up. The invention allows to for production of produce raw, gelled, frozen products (e.g. vegan bacon slices, vegan burger patties) without any heat treatment in the gelling process. The products can be heated after finalising the gelling process.

The new cold gelling procedure described in this invention can generally be used in the production of food products currently applying LM Pectin or alginates such as fruit fillings, fruit preparations, bakery cream fillings etc. The invention is also useful when using food products of vegetable origin.

DK163793B describes the production of feed products having a pH in the range of 5-8.5 by including pectates preferably having a degree of esterification (DE) of max. 20% and di-valent and tri-valent metal ions in the feed formulation being pasteurized or sterilized (autoclaved). The use of both pure commercial pectates as well as natural, raw sources rich in pectins, such as citrus peels, being de-esterified both by the natural pectin esterases in the peel as well as by chemical de-esterification are described. It's explained that the natural pectin esterases partially de-esterify the pectin molecule, and that the final heat treatment further de-esterify and solubilize the pectin molecule, which then upon cooling reacts with the di-valent cations to form a gel (DK163793B page 6, lines 1-7). The present invention is different, as the whole process is initiated in ice-water and have no heating steps.

JP2003334038A describes an enzyme preparation for paste product containing pectin esterase. It is described that it's desirable that the pectin gel can be formed at the same timing as that of the protein gel, and therefore it's taught that HM-pectin is decomposed into carboxyl groups upon heating through the presence of pectinesterase. Example 1 teaches how to mix the fish paste with a pectin/pectinesterase/CaCl₂) blend and immediately filled into a preformed casing and heated at 40° C. for 30 minutes and allowed to sit. Finally, it was heated to 85° C. for 40 minutes to produce a kamaboko. Example 2 describes a pork meat preparation to which the pectin/pectinesterase/CaCl₂) blend was added followed by stuffing into a preformed collagen casing and dried at 60° C. for 30 minutes and smoked at 60° C. for 10 minutes and steam cooked at 75° C. for 30 minutes. The present invention is different, as the whole process is maintained at cold conditions for example at 5° C.

WO2017062598A disclose a process for producing a gel composition comprising the steps of adding pectin, calcium lactate pectin methyl esterase to mango paste, whereafter the blended mixture was treated in a microwave pressure cooker and heated at full power for 6-7 minutes. The warm mixture was then transferred into suitable, single serving plastic cups, sealed and cooled to ambient temperature. However, such conditions are completely different to those covered by the present invention, where the gelling process is purely maintained at cold conditions.

Influence of calcium on pectin methylesterase behaviour in the presence of medium methylated pectins has been studied by Pauline Videcoq et al (Carbohydrate polymers, applied science publishers, Itd Barking, GB, vol. 86, no 4, 30 Jun. 2011, pages 1657-1664). In this study activity assays were conducted with medium methoxyl pectin and pectinesterase at 30° C. and pH=6. In the kinetics studies the pectin solutions were preheated at 50° C., after addition of pectinesterase solutions the mixtures were incubated at 30° C. The present invention is different, as the whole process is maintained at 5° C.

Gelation of high-methoxy pectin by enzymic de-esterification in the presence of calcium ions: a preliminary evaluation was studied by O'Brien A B et al (Carbohydrate research, Pergamon, GB, vol. 344, no. 14, 28 Sep. 2009, pages 1818-1823). HM pectin stock solutions were prepared at 1.25% at ambient temperature. 40 g of pectin stock solution was added to a beaker, 5 g CaCl₂) was added, 4.5 g water and 0.5 g enzyme solution to a total of 50 g. Observations were made at 20, 30, 40, 50 and 60° C. After gelation the samples were stored overnight (~16 hours) at 5° C. It's discussed that it seems possible to avoid syneresis by using Ca²⁺ concentration slightly below 50% stoichiometric and an incubation temperature no lower than ~30° C. However, the present invention demonstrates that gelling can be obtained with calcium concentrations higher than stoichiometric concentrations and at temperatures (~5° C.) far below ambient and is not obvious from the study by O'Brien et al.

Gelation of high methoxy pectin in the presence of pectin methylesterases and calcium was studied by Slavov A et al (Carbohydrate polymers, Applied Science Publishers, Ltd Barking, GB, vol. 77, no. 4, 10 Jul. 2009, pages 876-884). The pectin was dissolved at 2% in 50 mM MES buffer (2-[N-Morpholino] Ethane-Sulphonic acid) pH 6 by stirring overnight at 4° C. The enzymatic de-esterification of pectin was done by mixing slowly 2% pectin and 6 mM CaCl₂) solutions in 50 mM MES buffer pH6 preheated to 50° C. volume to volume to reach final solutions of 1% pectin and 3 mM CaCl₂). The present invention is different, as the whole process is initiated in ice-water and have no heating steps.

### SUMMARY OF THE INVENTION

The object of the present invention is to provide a gelling composition for producing an improved plant-based food product. The unique combination of the ingredients provides a way to produce a legally accepted, label friendly vegan meat alternative product without the need for neither methyl cellulose for the hot texture, nor other gelling agents for the cold texture. The pectins can be either used in addition to the alginate gelling or alone.

The invention provides a gelling process entirely performed under standard meat-plant cold preparation conditions and without the need for a hot pre-solubilization of the pectin sources.

The invention provides a gelling composition comprising calcium source, a pectin source and methylesterease. The gelling composition is then added to a protein or fruit fraction and the mixture is left for gelling.

The process is comprised by the steps of:
1. A process for producing a gel composition comprising the steps of:
a. Adding a dry blend of a calcium source, and a pectin source and methylesterase in powder form to a cold liquid preparation of fruit, vegetable or animal origin,
b. and mixing a) with 0-75% of a cold fruit, vegetable or protein fraction, the protein fraction being hydrated textured proteins or an animal-based raw material,
c. stuffing or forming the cold mixture and leaving it for gelling.

The gelled food product can be sliced, packed and sold frozen, or it can be cooked like a normal processed meat product and packed and sold either at 5° C. or frozen.

The enzyme, methylesterase, can be added either separately as a liquid preparation to the water or included in the dry blend when a lyophilized preparation is used.

### BRIEF DESCRIPTION OF THE DRAWINGS

FIG. 1: A schematic representation of the gel strength and pH relation of previously heated gel.

FIG. 2: Examples 1-12

FIG. 3: Results from Examples 1-12

FIG. 4: Examples 13-25

FIG. 5: Results from Examples 13-25

FIG. 6: Results from Examples 27-31

### DETAILED DESCRIPTION OF INVENTION

The present invention is based on studies described herein, which surprisingly demonstrate exceptional good quality of the gelling composition described to produce a food product for example a plant-based food product. The gelling composition comprising:
a. Pectin source and/or alginate source
b. Pectin methylesterase
c. Calcium source.

The gelling composition contains pectin source in the amount of 10-40% (w/w) of the gelling composition, pectin methylesterase in the amount of 0.5-15% of the gelling composition and calcium source in the amount of 50-400% relative (w/w) to the pectin source and/or alginate, the components adjusted to 100%

The invention provides a gelling process entirely performed under cold conditions and without the need for a hot pre-solubilization of the pectin sources. The process is comprised by the steps of:
a. Adding a dry blend of a calcium source, and a pectin source and methylesterase in powder form to a cold liquid preparation of vegetable or animal origin,
b. and mixing a) with 0-75% of a cold protein fraction, such as fruit, vegetable, hydrated textured proteins or an animal-based raw material,
c. stuffing or forming the cold mixture and leaving it for gelling.

The enzyme, methylesterase can be added either separately as a liquid preparation to the water or included in the dry blend when a lyophilized preparation is used.

In the context of the present invention “cold” process conditions means temperatures acceptable for food processing and manufacture. This would mean below 20° C. but above freezing temperatures (0° C.). This means preferably at or below 8° C., or at or below 5° C. In principle the temperature can shortly raise to for example above 10° C., however the process of the present invention will provide the desired product without these higher temperatures. After the gelling process, the products can optionally be heated.

In embodiments of the invention, the process as described above, wherein the gelling mixture is kept at refrigeration temperature for at least 30 minutes, or at least for two hours or overnight.

The enzyme has an optimum temperature for activity, and the temperature of the gelling mixture can be maintained at the optimum temperature for the methylesterase. In an embodiment, the methylesterase is used as a lyophilized preparation.

In embodiments of the invention the proteins can be animal-based or plant-based proteins.

In embodiments this can for example be plant-based protein selected from isolated soy, texturized soy protein, pea protein, wheat, canola, potato, rapeseed or combinations thereof. In embodiments the plant-based proteins constitute 0-25% of the gelling mixture. In embodiments the plant-based proteins are hydrated textured protein for a plant-based meat alternative product.

In embodiments wherein the protein is animal-based it can be mechanically deboned meat.

In embodiments the disclosed process can be applied to fruit-based systems.

In embodiments the disclosed process can be applied to a vegetable based system.

In embodiments the calcium source is a sparingly soluble calcium source, a coated or encapsulated calcium source, such as selected from the group of calcium sulphate, calcium citrate, calcium carbonate, di-calcium phosphate and encapsulated calcium lactate. In embodiments, the calcium source is delivering an amount of calcium corresponding to 0.05-20% of the pectin source and/or alginate content.

In embodiments the pectin source is pectin or citrus peel. In embodiments the pectin source is present in amounts of 0.1-10% by weight of the gel.

In alternative embodiments the gelling process as described in any of the embodiments of the invention also includes alginate. In embodiments the amount of pectin:alginate is 1:1 or preferably 3:1. In embodiments the amount of pectin:alginate is from 20%: 80% to 75%-25%, in embodiments 50%: 50%, in other embodiments 67%-33% and in embodiments 75%: 25%.

In embodiments where the calcium source is encapsulated calcium lactate, present from 10%-200% (w/w) the amount of the pectin source and/or alginate content. In embodiments the encapsulated calcium lactate is present in an amount of 0.5-8% by weight of the obtained gel.

In embodiments, the process of any of the preceding embodiments the gelling composition has a final pH of 2-7. In specific embodiments, the final pH is about 5.4-5.8. In other embodiments the pH is from 2.5-4. In particular embodiments the PH is 5-7.

In embodiments, the process of any of the above embodiments the gelling composition is added and mixed into the final food product mixture prior to forming the finished uncooked food product.

In embodiments the plant-based food product obtained by the steps of combining the minced gels obtained by the process described in any of the above embodiments are mixed with additional plant-based protein isolates.

Any of the embodiments above can be performed with plant-based proteins or animal-based proteins.

### Plant-Based Proteins

By plant-based protein we mean protein not stemming from pesco-, ovo-, lacto- or traditional animal meat-based sources. Plant-based proteins tend to have lower values of the essential amino acids such as leucine, isoleucine and valine, and consequently fail to trigger or promote muscle protein synthesis to the same degree. Additionally, antinutritional factors are also predominantly higher when compared with animal-based sources. However, although these components work to reduce ultimate digestibility of proteins, consumption of a balanced variety of plant-based protein does not place negative constraints on dietary efficacy. Indeed, these antinutritional factors can be mitigated by various procedures moving from germination techniques through fermentation and simple soaking of the plant material within standard culinary practice.

The plant-based proteins considered for the invention are selected from isolated soy, texturized soy protein, pea protein, wheat, canola, potato, rapeseed, mungbean, lupin, sunflower, rice, chickpea, oat, cassava, buckwheat, corn, spelt, linseed, arrowroot, sorghum, lentils, favabeans, navy beans, peanuts and almond, or combinations thereof.

### Soy Proteins:

Soy protein is produced from dehulled and defatted soybean meal, which is processed into three kinds of high protein commercial products: soy flour, concentrates, and isolates. Grinding soybeans to a fine powder result in soy flour, where three categories are prevalent: whole or full-fat, which contains natural oils; defatted, where the oil is removed and the protein content is 20-50%, and either high or low water solubility versions are available; and a lecithinated version is also standard, i.e. where lecithin is added to the soy. Soy protein concentrate (SPC) has a higher protein content, typically around 70%, and in broad general terms is simply defatted soy flour minus the water-soluble carbohydrates. Retaining much of the fiber of the original soybean and SPC examples are routinely used baked goods, breakfast cereals and significantly here, also in meat- and meat alternative products, where its function is to increase water and fat retention as well as enhance nutritional values. Isolated soy protein (ISP) has the highest degree of ‘protein’ purity of all the soy products and holds a minimum protein content of 90%. Also produced from the soy flour it additionally has all the non-protein components removed, and this credits it with a neutral flavour characteristic. ISP products can be used to improve the texture of meat, and meat analogue products as well as increasing the protein content and fortification of the application, whilst retaining moisture and possessing emulsifying properties. All soy protein types are widely used as functional or nutritional ingredients in a wide variety of food products. Here, soy protein concentrate, and isolated soy protein are the most common advocates for this invention's purpose, albeit the preferred version here is isolated soy protein. Furthermore, textured soy proteins produced in an extrusion process to provide chunks of different sizes are applied for the purpose of this invention.

In terms of protein quality, soy protein is one of the few plant-based proteins which has a Protein Digestibility Corrected Amino Acid Score (PDCAAS) at parity with traditional meat sources.

### Pea Proteins:

Equivalently, pea protein concentrates and isolates can be produced in manufacturing processes comprising protein extraction, purification, and drying unit operations.

Peas typically contain between 23 and 31% protein and thereafter 1-2% fat together with vitamins, polyphenols and minerals. The proteins themselves fall within the globulin, albumin, prolamin or glutelin types, of which albumins and globulins account for 10-20% and 70-80% respectively. The water-soluble albumin types are thought of as metabolic and enzymatic whereas the globulins are saline soluble and function as storage proteins for seeds. Beyond the protein, peas contain carbohydrates as a mixture of oligo, mono, di- and polysaccharides (up to 60-65%), where the main fraction is starch. Dietary fibre in the form of cellulose, hemicellulose, mucilage and resistant starches are also present at a level in the dried state of between 15-30%. Pea's fat content ranges from 1-2%, with about a quarter of that being made up of oleic acid, and half, linoleic acid. Minerals such as phosphorus, magnesium, calcium, iron, zinc, and copper are likewise present in diminishing order, as well as folic acid, riboflavin, niacin.

Pea protein, stemming typically from yellow and green split peas (Pisum sativum) is a rich source of non-proteinaceous nutrients such carbohydrates, vitamins and minerals and is generally low in fat. The protein content can be influenced by both genetic and environmental factors and is known to contain all essential amino acids required for the human diet. Functionally, it can be used as a thickener, foaming agent, emulsifier or structuring ingredient.

In a preferred embodiment of the invention the plant-based proteins are isolated or textured soy proteins or pea proteins.

In the present invention, the isolated vegetable Plant-based protein most preferred used are based on commercial product Supro® EX37 HG and/or Trupro® 2000. Total protein content being min 90%.

In the invention, the plant-based proteins are added in an amount 0-35%, such as for example 0-25%, 5-35%, 10-30%, or for example 15-30% by weight of the obtained gel.

### Animal-Based Proteins:

Animal-based proteins include proteins from meat, fish, eggs and milk. In examples of the invention skimmed milk powder has been used.

Mechanically deboned meat (MDM) is a paste-like meat product produced by forcing pureed or ground beef, pork, mutton or carcasses of turkey or chicken, under high pressure through a sieve or similar device to separate the bone from the edible meat tissue.

Mechanical deboned meat (MDM) appears as a paste having no meat texture. Methods to create texture of MDM would include alginate gelling systems based on alginate, a calcium source (typically CaSO₄) and a sequestrant (typically polyphosphates). This invention demonstrates a strong gelling of chicken MDM without any phosphates as shown in example 35.

### Pectin:

Pectin is a commonly used additive in the food industry. It is useful, for example, as a stabilizing agent, thickener and gelling agent in, for example, jams and other fruit-based products as well as in sour milk-based products such as yogurts. Pectin has also found other uses in the food industry, for example use as a fat replacer.

Pectin is a structural polysaccharide typically found in the form of a water insoluble parent pectic substance—protopectin—in the primary cell wall and the middle lamella of green land plants such as fruit and vegetables. Major sources of commercial pectin products are citrus peel and apple pomace in which protopectin represents 10-40% by weight of the dry matter. The “degree of esterification” (DE) means the extent to which free carboxylic acid groups contained in the galacturonic acid units of pectin have been methyl esterified. If more than 50% of the carboxyl groups are esterified, then the resultant pectin is referred to as “high ester pectin” (“HE pectin” for short). If less than 50% of the carboxyl groups are esterified, then the resultant pectin is referred to as a “low ester pectin” (“LE pectin” for short or a “low methoxyl pectin”). If the pectin does not contain any—or only a few—esterified groups, it is usually referred to as pectic acid.

Low methoxyl (LM) Pectin is another hydrocolloid which gels with calcium ions providing both cold and hot textures. However, pectins are traditionally solubilized in hot water and furthermore the stability at neutral pH is very limited, the pH in foods stabilized with pectin being typically below 4.5.

LM pectin is produced industrially from high methoxyl (HM) pectin by the used of pectin methyl esterase enzymes or acids. However, LM pectin can also be produced in-situ in the foodstuff, by applying HM pectin or citrus fiber products being rich in HM pectin together with pectin methyl esterase enzymes, for example RAPIDASE FP SUPER from DSM Food Specialties B.V., and a calcium source like calcium sulphate in the foodstuff.

Fiberstar has described the use of such a system, but with use of citrus fiber, to produce burgers. However, the texture of the burgers is quite brittle and crumbly i.e. not very cohesive, and the process involves the pre-solubilization of the ingredients in hot water.

However, as demonstrated in the present invention, pre-solubilization in hot water is not required when the pectin together with a calcium source and a pectin methyl esterase when mixed together and simply kept in the fridge overnight.

In an embodiment pectin with methylesterases are mixed together in situ produces a preferred gelled structure, without the need for lowering the pH by the addition of acids.

In the context of the present invention HM and LM pectins and mixtures thereof are used. In embodiments 0.1-10% of pectin is used in the gelling composition.

In the context of the present invention “pectin source” means any of the above described pectins and pectin sources alone or in combination.

In the context of the present invention methylesterases is intended to mean any methylesterase capable of demethylation of pectin. Commercially available methylesterases are enzymes such as RAPIDASE FP SUPER from DSM Food Specialties B.V. In the context of the present invention the enzymes is used in amounts of 0.01-1% of the total product, such as for example 0.02-0.8%, 0.02-0.7%, 0.026-0.65%, or about 0.13%.

### Alginate Salts:

Alginates, derived from, inter alia, brown seaweeds are linear, unbranched bio-polymers consisting of (1-4)-linked β-D-mannuronic acid (M) and α-L-guluronic acid (G) residues. Alginates are not random copolymers but consist of blocks of similar and alternating sequences of residues, for example, MMMM, GGGG, and GMGM.

Also called algin, alginate is an anionic polysaccharide distributed widely in the cell walls of brown algae, where through binding with water it forms a viscous gum. In extracted form it absorbs water quickly; it is capable of absorbing 200-300 times its own weight in water. Alginate can form heat stable gels with di-valent cations, preferably Calcium. Physical properties of alginates depend on the relative proportion of the M and G blocks. Gel formation at neutral pH requires a calcium source to provide calcium ion to interact with G-blocks. The greater the proportion of these G-blocks, the greater the gel strength.

“Alginate” is the term usually used for the salts of alginic acid, but it can also refer to all the derivatives of alginic acid and alginic acid itself; in some publications the term “algin” is used instead of alginate. Alginate is present in the cell walls of brown algae (Phaeophyceae sp.) as the calcium, magnesium and sodium salts of alginic acid. The goal of the extraction process is to obtain dry, powdered, sodium alginate or potassium alginate. The calcium and magnesium salts do not dissolve in water; the sodium and potassium salts do. The rationale behind the extraction of alginate from the seaweed is to convert all the alginate salts to the sodium or potassium salt, dissolve this in water, and remove the seaweed residue by filtration. The alginate must then be recovered from the aqueous solution. The solution is very dilute, and evaporation of the water is not economic. There are two different ways of recovering the alginate.

The first is to add acid, which causes alginic acid to form; this does not dissolve in water and the solid alginic acid is separated from the water. The alginic acid separates as a soft gel and some of the water must be removed from this. After this has been done, alcohol is added to the alginic acid, followed by sodium carbonate or potassium carbonate which converts the alginic acid into sodium or potassium alginate. The sodium or potassium alginate does not dissolve in the mixture of alcohol and water, so it can be separated from the mixture, dried and milled to an appropriate particle size that depends on its application.

The second way of recovering the sodium alginate from the initial extraction solution is to add a calcium salt. This causes calcium alginate to form with a fibrous texture; it does not dissolve in water and can be separated from it. The separated calcium alginate is suspended in water and acid is added to convert it into alginic acid. This fibrous alginic acid is easily separated, placed in a planetary type mixer with alcohol, and sodium or potassium carbonate is gradually added to the paste until all the alginic acid is converted to sodium or potassium alginate. The paste of sodium or potassium alginate is sometimes extruded into pellets that are then dried and milled.

In the present invention, alginate salts are added in an amount of 0-5.0%, preferably 0-1.5% by weight of the obtained gel.

### Calcium Source:

A calcium source should be understood as any compound able to deliver calcium ions to the composition in the proper controlled way according to the process.

In the context of the present invention the calcium source is a sparingly soluble calcium containing compound or encapsulated calcium compound.

In this invention, the preferred calcium source is selected from the group of calcium sulphate, calcium carbonate, calcium citrate, di-calcium phosphate and encapsulated calcium lactate.

In a preferred embodiment of the invention, calcium source used is a self-gelling alginate and/or pectin source, which is a mix of calcium sulphate and sequestrant.

Calcium sulphate is an inorganic compound with the formula CaSO₄. It is known in the E number series as E516. Solubility for the dihydrate is 0.24 g/100 g at 20° C., and the solubility product is 3.14×10⁻⁵ mol²L⁻². In the present invention it's used as a sparingly soluble calcium salt.

The encapsulated calcium lactate is present in an amount of 1-8%, preferably 2.4-4.5% by weight of the obtained gel. Encapsulated calcium lactate is present from half (w/w) the amount of the alginate and/or pectin alginate to four times the amount of the alginate and/or pectin.

A sequestrant is used along with alginate and calcium when a delay of the gel formation is needed. TSPP, functioning as a sequestrant, also called sodium pyrophosphate or tetrasodium phosphate or TSPP, is an inorganic compound with the formula Na₄P₂O₇. As a salt, it is a white, water-soluble solid. It is composed of the pyrophosphate anion and sodium ions. Tetrasodium pyrophosphate is used as a buffering agent, an emulsifier, a dispersing agent, and a thickening agent, and is often used as a food additive. In the present invention it is used as a sequestrant having a stronger affinity for calcium than alginate and/or pectin sources. The sequestrant in the present invention is selected from the group of tetrasodium pyrophosphate, sodium-hexametaphosphate and sodium citrate.

In one of the preferred embodiments of the invention, the calcium source is used in a self-gelling alginate and/or pectin sources (CaSO₄, sequestrant (TSPP)) consisting of 40-70%, more preferably 50-60% of alginate salt, and the content of the sequestrant (TSPP) is 30-60% of the content of the sparingly soluble calcium salt by dry weight of the composition.

In a preferred embodiment of the invention, the calcium source used is encapsulated calcium lactate such as MeatShure®416 (or previously known as Textureze MT 230). Ingredient statement: Calcium Lactate Pentahydrate, Hydrogenated Vegetable Oil & Monoglycerides with 48-52% Calcium Lactate Pentahydrate and a particle size of 2% Maximum on #14 Mesh Screen (USSS).

In addition to the above the compositions may contain or added during the process other ingredients such as flavors, color, starch, pH adjusting etc. as known in the art.

Additionally, the invention covers a plant-based food product containing the gel composition obtained by the gelling composition above described, in amounts of 10-100% of the plant-based food product.

The plant-based food product could be a burger, sausage, nuggets, bacon, schnitzels and the like.

A process for obtaining a plant-based food product is also object of the invention, wherein the gelling composition previously described is added and mixed into the final food product mixture prior to forming the finished uncooked food product.

In the context of the present invention “about” means the stated value optionally ±10%, such as ±5%.

### General Description of Material and Methods

### Texture Analyser

A texture analyser (TA/TX2 with 10 mm probe, distance 15 mm, speed 2 mm/s) has been used to measure strength of the formed gel between self-gelling alginate/alginate and/or pectin-methylesterase systems and plant-based proteins. Texture was measured at 5° C. or 75° C., to assess cold and hot texture respectively.

A gel strength test measures the amount of force needed to rupture and penetrate into the a specimen gel and the resulting area under the stress-strain curve is reported. In this case the functional system was utilised in the formation of a gel, in the presence of pectin-methylesterase and/or an alginate, calcium source, sequestrant and a protein.

The formed gels consisted of different concentration of pectins, alginate, alginate type, different calcium sources and sequestrant as well as different proteins.

### Test Procedure

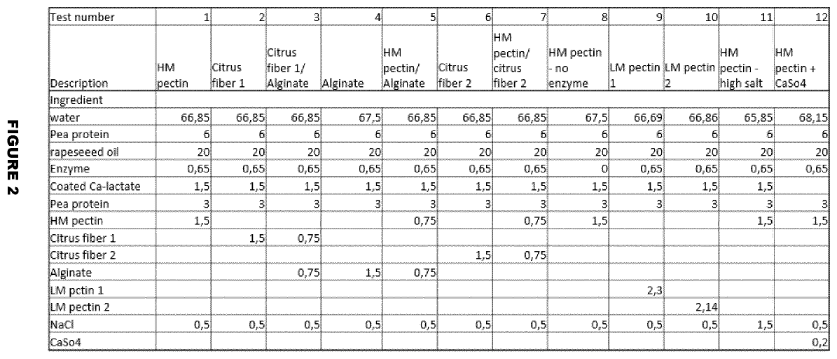

A number of experiments were performed to test how pectin, citrus fiber, alginate or blends hereof could form gels during a cold manufacturing process. The experimental setup is described in detail in FIG. 2.

All samples were produced by the same method, unless otherwise described for the specific test. First a pre-blend of pea protein, a calcium source (Coated Calcium lactate or uncoated Calcium sulphate), NaCl and the used hydrocolloid (HM pectin, LM pectin, Alginate, Citrus fiber) was made.

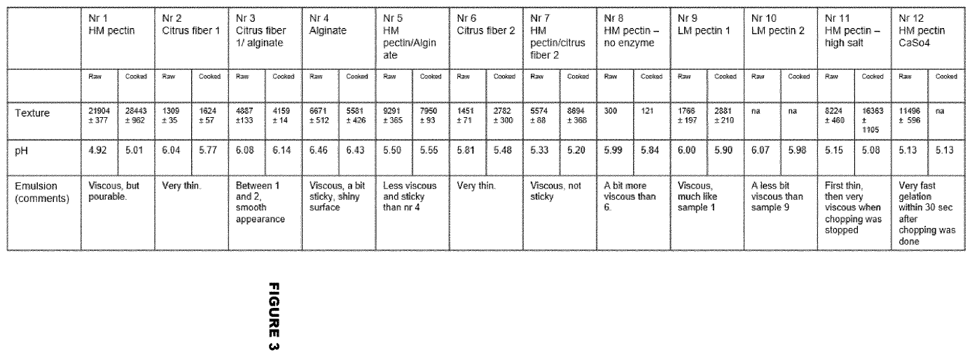

In a Stephan mixer cold tap-water and pea protein was mixed to hydrate the protein. Rapeseed oil was added, and a low viscous emulsion formed. A liquid preparation of the methylesterase was then added. The pre-blend was added and mixed to form the final emulsion. The emulsion was put in cans and put to gel overnight at 5° C., or as an alternative, the can was held at 40° C. for 1 hour to increase the activity of the enzyme. Next day a subset of the cans were heated 45 min at 90° C., and then cooled again to 5° C., while the other subset of cans were still kept at 5° C., and not subjected to any heat treatment. During production a qualitative measurement were collected for viscosity and appearance of the emulsions, as well as gelation time, defined as the time to set a solid gel. Quantitative data on gel hardness were collected for all gels. Gel-strength was measured by a penetration test with a cylindrical probe (SMS P/10) penetrating into the cold sample (5° C.) or hot sample (75° C.) Results for the current setup are displayed in FIG. 3. It is surprising that a HM pectin in combination with pectin methyl esterase, and coated calcium lactate in this cold process has a resulting gel strength of 3-5 times higher than a gel made with alginate, however with some syneresis. The importance of the use of pectin methyl esterase was shown in trial nr 8, where the enzyme was omitted and as a result no gel was formed. The effect of the use of a coated calcium source was also tested (trial 12). Here uncoated calcium sulfate was used, and a gel were formed within 30 seconds after the mixing was stopped. A delay in gelation is of high importance for industrial production and for the general applicability of this invention.

Two types of citrus fiber were also tested (trial 2 and 6). Both samples produced emulsions with low viscosity and the gels were also softer than the HM pectin sample, but a gel was formed.

Different mixtures of the used hydrocolloids were tested, the most promising mixture was alginate and HM pectin in a 1:1 ratio. The resulting gel was harder than alginate alone and did not show excessive syneresis.

Two samples of LM pectin were used (trial 9 and 10), one sample produced a gel while the other did not. The resulting gel was much softer than the HM pectin sample (trial 1) showing that in situ production of LM pectin has a benefit compared to use of an commercial type of LM pectin.

As seen in FIG. 3, it's possible to produce plant-based products according to this invention having a pH in the slightly acid range without any need for adding acids like vinegar, as the de-methylation causes a pH drop, which can be buffered by the proteins and buffer salts to a desired pH. A pH in slightly acidic range for plant-based meat alternatives can be desired for shelf stability reasons.

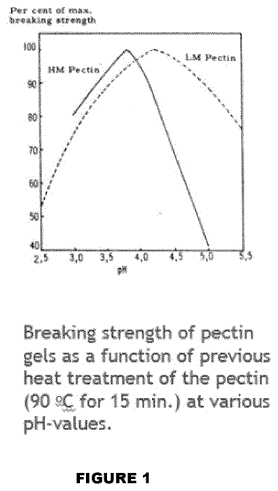

It is well-known that hydrolysis (loss of gelling power) of gelling hydrocolloids at certain pH and temperatures is only taking place in the sol state, and not in the gel state. Therefore, it is a surprising finding that no pre-solubilization is required for an in-situ de-esterification of pectin to produce a gelled product at low temperature with a high gel strength also at a pH close to neutral. This is not the case, when the pectins are exposed to high/neutral pH in the sol state, as shown in FIG. 1, i.e. the cold in-situ de-esterification bypasses the sol-state at high temperature.

All values for the experimental section is presented in (w/w)

FIG. 2 shows experimental setup for the completed exemplary work. The table presents trial numbers and used ingredients in percentage.

FIG. 3 shows the results of examples 1-12. Results from experimental work. Texture measurements at 5° C. (total area under curve), pH, description of emulsion characteristics and description of the final gel. Samples were either cooked or uncooked (raw).

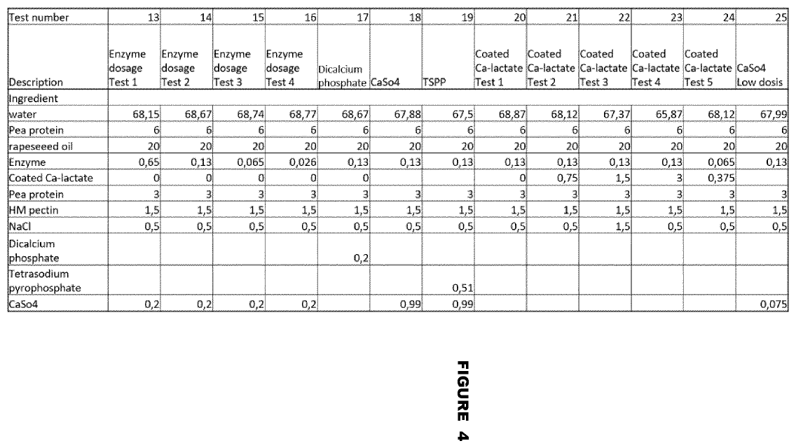

FIG. 4 shows the examples 13-25 and the experimental setup for the completed exemplary work. The table presents trial numbers and used ingredients in percentage

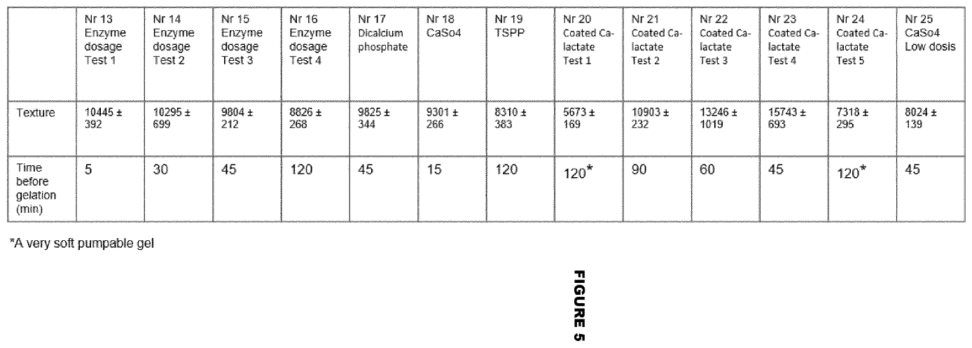

FIG. 5 shows the results of examples 13-25: Texture measurements at 5° C. (total area under curve). Determination of gelation time, all samples were uncooked (raw).

### Results:

Enzyme dose: The results show that the enzyme dose is an important factor controlling gelation time, when a slow-release calcium source as CaSO₄ is used (experiment 13-16). It was possible to decrease enzyme amount 10-fold, increase time before gelation from 5 to 45 min, while still maintaining a similar final texture. A 25-fold reduction in enzyme dosage extended gelation time to 120 min but resulted in a slightly softer gel (experiment 16).

### Calcium Sources and Concentration:

The choice of calcium source, addition of sequestrant or coating of calcium did show a great effect on both gelation time and the final gel strength.

Experiment 20 showed that the system will start to gel also without addition of externally added calcium. The calcium in the water and the other ingredients e.g. 250 mg/100 g present in the used pea protein isolate, is enough calcium to start gelation. However small additions of extra calcium will provide an enhanced gel structure, e.g. 0.075-0.2% CaSO₄. When applying other calcium sources than CaSO₄ the results show an extended time before gelation. Dicalcium phosphate showed slightly longer gelation time than a similar concentration of CaSO₄, while the addition of the sequestrant Tetrasodium Pyrophosphate had a significant effect on gelation time, extending it from 15 min to 120 min at a similar dose of CaSO₄ (experiment 18 & 19).

Use of coated Calcium lactate did show an advantage both regarding extending the gelation time, and resulting in stronger gels, compared to the use of CaSO₄. An increase in the dosage of coated calcium lactate had a positive relationship with the resulting gel strength but a negative relationship with gel time.

TABLE 1
(experimental and results of experiment 26)

| | Test number |
|---|---|
| | 26 |
| | Description |
| Ingredient | High protein test |
| water | 71.07 |
| Soy protein | 20 |
| Enzyme | 0.13 |
| Soy protein | 5 |
| HM pectin | 1.5 |
| NaCl | 0.5 |
| CaSo4 | 1 |

Nr 26
High protein test

| | Cold | Cooked |
|---|---|---|
| Texture | 17280 ± | 25134 ± |
| | 445 | 232 |
| pH | nd | 5.75 |

| | |
|---|---|
| Emulsion | Highly viscous |

(comments)

Experiment 26 show it is possible to make gels with the addition of 25% soy protein isolate. The gel strength can be further enhanced if the gel is cooked after the initial gelation process

TABLE 2
(Examples 27-31)

| | Test number | | | | |
|---|---|---|---|---|---|
| | 27 | 28 | 29 | 30 | 31 |
| | Description | | | | |
| | | | | HM pectin | HM |
| | | Alginate/ | | (enzyme | pectin |
| | Algi- | HM | HM | temperature | (higher |
| Ingredient | nate | pectin | pectin | optimum) | dosage) |
| water | 68.5 | 68.37 | 68.37 | 68.37 | 63.87 |
| Pea protein | 14 | 14 | 14 | 14 | 14 |
| rapeseeed oil | 7 | 7 | 7 | 7 | 7 |
| Enzyme | | 0.13 | 0.13 | 0.13 | 0.13 |
| Coated Ca- | 5 | 5 | 5 | 5 | 8 |
| lactate | | | | | |
| Pea protein | 3 | 3 | 3 | 3 | 3 |
| alginate | 2.5 | 1.25 | | | |
| HM pectin | | 1.25 | 2.5 | 2.5 | 4 |

Experimental setup for the completed exemplary work. The table presents trial numbers and used ingredients in percentage

Samples were produced as described in the introduction, except for sample nr 30. For sample 30, after the cold mixing procedure, the canned samples were held at 40° C. for 1 hour to optimize the activity of the enzyme. The samples were then immediately cooked for 45 min at 90° C.

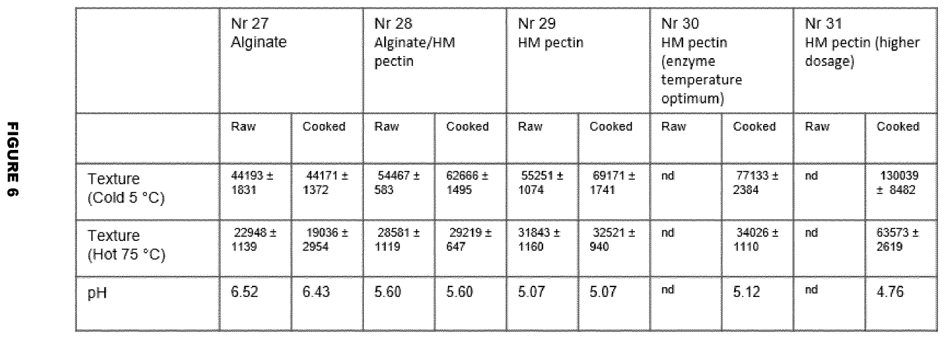

FIG. 6 shows the result of examples 27-31: Texture measurements (total area under curve, at 5° C. or 75° C.), pH. Samples were either cooked or uncooked (raw).

### Results

In FIG. 6, both samples that was either gelled cold or subjected to a heat treatment was measured by a penetration test at 5° C. or 75° C. When comparing the texture measured at both 5° C. or 75° C. for both raw and cooked samples of 27, 28 and 29, it is evident that blending pectin and alginate, or having a pure pectin gel, the result is increased texture compared to alginate alone. Cooking of the samples with pure pectin or a pectin-alginate mixture resulted in higher textural values compared to the uncooked (raw) sample.

Comparing sample 30 to 29, it is shown that subjecting the sample to a one hour holding time at 40° C., results in comparable texture to the sample held at 5° C. overnight.

For sample 31 an increased pectin dosage of 4% was used, this results in both increased cold and hot texture, but an even lower pH, compared to samples with 2.5% pectin.

TABLE 3
(water and orange juice gels)

Test number

| | | |
|---|---|---|
| 32 | 33 | 34 |

Description

| | | | orange |
|---|---|---|---|
| | | | juice + 30% |
| Ingredient | Water | orange juice | sucrose |
| water | 96.67 | | |
| orange juice | | 96.67 | 66.67 |
| Sucrose | | | 30 |
| Enzyme | 0.13 | 0.13 | 0.13 |
| HM pectin | 1.5 | 1.5 | 1.5 |
| Dextrose | 1.5 | 1.5 | 1.5 |
| CaSo4 | 0.2 | 0.2 | 0.2 |

TABLE 4
(results)

| | | | | | Nr 34 | |
|---|---|---|---|---|---|---|
| | Nr 32 | | Nr 33 | | Orange juice + | |
| | Water | | Orange juice | | 30% sucrose | |
| | Cold | Cooked | Cold | Cooked | Cold | Cooked |
| Texture | 3089 ± | 1527 ± | 4367 ± | 2671 ± | 2484 ± | 5088 ± |
| | 191 | 70 | 346 | 76 | 172 | 175 |
| pH | 2.91 | 2.93 | 3.43 | 3.46 | 3.35 | 3.35 |

### Procedure:

1. Premix pectin and dextrose
2. Dissolve sucrose in orange juice, cool down to 5° C.
3. Add enzyme to the cold liquid fraction. Dispense the pectin mixture into the liquid with a IKA mixer with propeller and stir for 2 minutes at high speed.
4. Put liquid in a can to gel overnight at 5° C. Heat half of the cans next day for 45 min at 90 C. Measure texture in cans with penetration test at 5° C.

### Cooking Procedure for Heat Stability:

Pre-heat convection oven to 200° C. Put 100 g gel on a plate and cook for 10 minutes at 200° C. Assess heat stability and melting of the gel.

### Results

Gelation of water, orange juice and an orange juice with 30% sucrose could be achieved by the cold gelling mechanism described in this invention.

Heating of the gels in cans for 45 min at 90° C. resulted in lower texture for the samples with water and orange juice, but the sample with 30% sugar achieved an even higher texture after heating and cooling.

Heat stability was assessed to test the gels in relation to heat stable fillings used in bakery. The water gel showed a low heat stability, but the sample with orange juice and the sample with orange juice and 30% sucrose showed stability during the cooking process.

TABLE 5
Example 35

| | |
|---|---|
| Ice-Water | 32% |
| Chicken MDM | 64.87% |
| Pectin 1251 | 1.50% |
| Textureze MT 230 | 1.50% |
| Rapidase FP | 0.13% |
| Super | |
| Total | 100% |

### Procedure:

1. Add the Rapidase enzyme to the water in the Stéphan
2. Add the chicken MDM and chop on speed II to homogeneity
3. Add the blend of pectin and Textureze MT 230 and chop on speed I for 1 minute under vacuum.
4. Put the mass in suitable cans and leave them at 5° C. over-night.

TABLE 6
Texture analyzer results:

Test ID

| | Total Area | Total Area |
|---|---|---|
| | g · mm | g · mm |
| | Area F-D 1:5 | Area F-D 1:5 |
| | COOKED | RAW |
| Start Batch 4317-1-5.cooked. | | |
| 4317-1-5.cooked.01 | 22020.949 | 14215.583 |
| 4317-1-5.cooked.02 | 22700.882 | 11091.569 |
| 4317-1-5.cooked.03 | 21260.706 | 13333.898 |
| End Batch 4317-1-5.cooked. | | 10824.757 |
| Average: | 21994.179 | 12366.452 |
| S.D. | 720.461 | 1669.070 |
| Coef. of Variation | 3.276 | 13.497 |

Raw: cans kept at 5° C.; Cooked: Cans heated to 70° C. in the oven for one hour and cooled to 5° C. before measurement.

TABLE 7
(Examples 36-38) Preparation of a gel
with aid of a freeze dried enzyme

| | Test number | | |
|---|---|---|---|
| | 36 | 37 | 38 |
| | Description | | |
| | Control | Freeze dried | Freeze dried |
| | Liquid | enzyme test 1 | enzyme test 2 |
| Ingredient | enzyme | 0.13% | 0.65% |
| water | 65.07 | 65.2 | 65.2 |
| Pea protein | 6 | 6 | 6 |
| rapeseed oil | 20 | 20 | 20 |
| Enzyme | 0.13 | | |
| Coated Ca-lactate | 3 | 3 | 3 |
| Freeze dried enzyme | | 0.75 | 0.75 |
| with pea protein | | | |
| Pea protein | 3 | 2.25 | 2.25 |
| HM pectin | 2.3 | 2.3 | 2.3 |
| NaCl | 0.5 | 0.5 | 0.5 |

Experimental setup for the completed exemplary work. The table presents trial numbers and used ingredients in percentage

Procedure: A 15% w/w pea protein in water slurry was prepared in a Stephan mixer. 50 g slurry was transferred to a plastic cup and either 1.3 g or 6.5 g Rapidase enzyme added, and stirred into the pea protein slurry. The final mixture was frozen to −18° C., and freeze-dried. The resulting freeze dried powder was mixed with encapsulated calcium lactate, addition pea protein isolate, and the pectin source, to produce an all-in-one blend containing all active ingredients needed for gelation.

The blend was added to the pea protein emulsion as described previously, and let to gel overnight at 5° C. Next day, texture was measured at 5° C. for the samples and compared to a control were liquid enzyme at a similar dosage was used (Table 13).

TABLE 8
Results from experimental work. Texture measurements (total
area under curve, at 5° C.), Samples were uncooked (raw).

| | | Nr 37 | Nr 38 |
|---|---|---|---|
| | Nr 36 | Freeze dried | Freeze dried |
| | Control | enzyme test 1 | enzyme test 2 |
| | Liquid enzyme | 0.13% | 0.65% |
| Texture | 17197 ± 561 | 17567 ± 1297 | 19490 ± 254 |
| (Cold 5° C.) | | | |

TABLE 9
Pectin-alginate synergy.

| | Test 39 | Test 40 | Test 41 | Test 42 | Test 43 |
|---|---|---|---|---|---|
| | Pectin/Alginate 1:1 | Pectin/Alginate 2:1 | Pectin/Alginate 3:1 | Pectin | Alginate |
| Water | 63.25% | 63.25% | 63.25% | 63.25% | 63.25% |
| Pea Protein | 19.35% | 19.33% | 19.35% | 19.29% | 19.31% |
| Native Maize starch | 1.00% | 1.00% | 1.00% | 1.00% | 1.00% |
| Rapeseed oil | 7.00% | 7.00% | 7.00% | 7.00% | 7.00% |
| Methylesterase | 0.13% | 0.13% | 0.13% | 0.13% | 0.13% |
| HM pectin | 1.17% | 1.63% | 1.79% | 2.42% | 0.00% |
| Coated calcium lacate | 4.84% | 4.79% | 4.81% | 4.84% | 4.95% |
| Potassium alginate | 1.19% | 0.80% | 0.60% | 0.00% | 2.37% |
| Flavours | 1.08% | 1.08% | 1.08% | 1.08% | 1.08% |
| Colours | 1.00% | 1.00% | 1.00% | 1.00% | 1.00% |
| | 100% | 100% | 100% | 100% | 100% |
| pH after gelling at 5° C. | 5.78 | 5.56 | 5.49 | 5.25 | 6.55 |
| Breaking Gelstrength (g) at 5° C. | 3332 | 3254 | 4400 | 3755 | 2675 |

Procedure: Preparation, gelling and all measurements done at 5° C. Put liquid flavors in the oil and add the oil plus the methylesterase water/ice (75/25) in the Stephan.

Then add the pea protein and chop at speed III for one minute under vacuum. Scrape down.

Then add the flavors, the colors, and the potato starch. Then chop for 2 minutes at speed III under vacuum. Scrape down.

Add the alginate, HM pectin and the coated calcium lactate to the Stephan. Then chop at speed I for 1.5 minutes under vacuum.

Stuff in cans (134 g) and store the cans at 5° C.

The 2^{nd} day. Measure gel strength at 5° C.

TABLE 10
Test 44. Preparation of sugar-reduced marmalade with
standard amidated low-es-ter pectin (control).

| Ingredients | Control recipe (Test 44) |
|---|---|
| Water | 14% |
| GRINDSTED ™ Pectin SF 560 | 0.9% |
| Sucrose | 24.23% |
| Frozen Strawberries | 45% |
| Lemon Juice concentrate | 0.7% |
| Water | 19.27% |
| Evaporation | 4% |

Procedure: Mix fruit, sugar and water in the thermomixer and heat to 90° C. When the temperature reaches 90° C., dissolve pectin in hot water (80° C.) using a high-speed mixer and add the pectin solutions to the fruit mixture. Adjust to the desired PH ~3 with the lemon juice concentrate. Cool to 80° C. and fill.

TABLE 11
Preparation of sugar reduced marmalade with
HM pectin and methylesterase at 5° C.:

| | Test 45 | Test 46 | Test 47 | Test 48 |
|---|---|---|---|---|
| Water | 23.57% | 9.57% | 23.77% | 9.77% |
| HM Pectin | 0.60% | 0.60% | 0.40% | 0.40% |
| Sucrose | 30.00% | 44.00% | 30.00% | 44.00% |
| Frozen strawberries | 45.00% | 45.00% | 45.00% | 45.00% |
| Lemon juice concentrate | 0.60% | 0.60% | 0.60% | 0.60% |
| Methylesterase | 0.13% | 0.13% | 0.13% | 0.13% |
| Calcium sulphate | 0.10% | 0.10% | 0.10% | 0.10% |
| | 100.00% | 100.00% | 100.00% | 100.00% |
| Brix: | 33.0 | 46.5 | 33.5 | 48.5 |
| pH: | 3.1 | 3.2 | 3.1 | 3.2 |

Procedure: For trial 45 and 47: Prepare the sugar solution in advance (the day before), so it's free of air bubbles.

For trial 46 and 48: The sugar fruit and water are mixed the day before to minimize air bubbles from the solubilization of the sugar as much as possible.

Add the methylesterase to the solution of sugar (45 and 47), and to the sugar-fruit-water (trial 46 and 48) in the thermomix.

Add the pectin and the CaSO₄ and mix until homogeneity.

Adjust the pH to 3.3 with the lemon juice concentrate.

Fill into cans (134 g) and place the cans in the fridge to gel overnight. The next day a can from each trial is heated to 100° C. for 45 minutes to pasteurize the product and then cooled to 5° C.

TABLE 12
All gel strengths measured at 5° C. (breaking
strength) with a ½ inch probe.

Gelstrength at 5° C. (g)

| | | Gelled cold then |
|---|---|---|
| Test 44 (control): 226 g | Gelled Cold | pasteurized |
| Test 45 | 727 | 564 |
| Test 46 | 344 | 272 |
| Test 47 | 644 | 367 |
| Test 48 | 181 | 150 |

TABLE 13
(Examples 49-56) Preparation of a gel with pectin sources
of different Degree of Esterification (DE). The table
presents trial numbers and used ingredients in percentage

| | Test number | | | | | | | |
|---|---|---|---|---|---|---|---|---|
| | 49 | 50 | 51 | 52 | 53 | 54 | 55 | 56 |
| | Description | | | | | | | |
| | DE | DE | DE | DE | DE | DE | DE | DE |
| Ingredient | 29 | 33 | 34 | 46 | 56 | 66 | 70 | 82 |
| water | 66.4 | 65.7 | 65.6 | 66.4 | 66.4 | 66.4 | 64.4 | 64.4 |
| Pea protein | 6 | 6 | 6 | 6 | 6 | 6 | 6 | 6 |
| rapeseeed oil | 20 | 20 | 20 | 20 | 20 | 20 | 20 | 20 |
| Enzyme | 0.13 | 0.13 | 0.13 | 0.13 | 0.13 | 0.13 | 0.13 | 0.13 |
| Coated | 3 | 3 | 3 | 3 | 3 | 3 | 3 | 3 |
| Ca-lactate | | | | | | | | |
| Pea protein | 3 | 3 | 3 | 3 | 3 | 3 | 3 | 3 |
| Pectin | 1.5 | 1.5 | 1.5 | 1.5 | 1.5 | 1.5 | 1.5 | 1.5 |
| sucrose | | 0.64 | 0.81 | | | | | |

The produce was done as described previously in the method section. The samples were after cold mixing, kept cold in the fridge overnight, and texture measured the next day at 5° C.

TABLE 14
Results from experimental work (Examples 49-56). Texture measurements (total
area under curve, at 5° C.), and pH. Samples were uncooked (raw).

| | Test nr | | | | | | | |
|---|---|---|---|---|---|---|---|---|
| | 49 | 50 | 51 | 52 | 53 | 54 | 55 | 56 |
| | DE | DE | DE | DE | DE | DE | DE | DE |
| | 29 | 33 | 34 | 46 | 56 | 66 | 70 | 82 |
| Texture | 4358 ± | 14720 ± | 16249 ± | 20350 ± | 17970 ± | 18648 ± | 25459 ± | 25471 ± |
| | 97 | 461 | 413 | 547 | 384 | 245 | 1319 | 445 |
| pH | 6.09 | 5.33 | 5.83 | 5.33 | 5.24 | 5.12 | 5.16 | 5.02 |

The results show that not only HE-pectin, but also LE pectin can function as a substrate for the in-situ cold gelatin process. Stronger gels are achieved if the DE is above 30, and even stronger if above 70. Except for test nr 50, a gradual decrease in pH was observed as the DE increased.

TABLE 15
(Examples 57-59) Preparation of ketchup with pectin or citrus fiber

Test number

| | | |
|---|---|---|
| 57 | 58 | 59 |

Description

| Ingredients | Ketchup 1 | Ketchup 2 | Ketchup 3 |
|---|---|---|---|
| water | 42.67 | 42.42 | 41.57 |
| sucrose | 20 | 20 | 20 |
| pectin | 0.5 | | |
| Citrus fiber | | 0.75 | 1.50 |
| Calcium sulphate | 0.1 | 0.1 | 0.2 |
| enzyme | 0.13 | 0.13 | 0.13 |
| salt | 0.5 | 0.5 | 0.5 |
| spices | 0.1 | 0.1 | 0.1 |
| Tomato | 30 | 30 | 30 |
| concentrate | | | |
| 12% vinegar | 6 | 6 | 6 |

Procedure: Add cold water and enzyme to a Thermomix.
Dry blend the following ingredients: sucrose, salt, spices, pectin or citrus fiber, calcium.
Add the dry blend to the water and mix at speed 2.5 for 30 sec,
Mix for additional 1.5 minutes at speed 6.
Add tomato paste and vinegar and mix at speed 3 for 1 min.
Transfer sample to a bucket and store cold overnight.
Next day transfer gelled material to Thermomix and chop to a smooth consistency at speed 6 for 2 min.

TABLE 16
Results from experimental work (Examples 57-59).
Shear rate measurements performed at 20° C.

Test number

| | 57 | 58 | 59 |
|---|---|---|---|
| | Ketchup 1 | Ketchup 2 | Ketchup 3 |
| Shear rate (1/s) | 1 | 1 | 1 |
| Viscosity (Pa*s) | 32.5 | 11.0 | 26.1 |

Rheology of the ketchup samples was measured by a rheometer with a bob-cup system at a shear rate for 0.1-100 1/s. The values at a shear rate of 1 is reported.

TABLE 17
(Examples 60-62) Preparation of instant bakers custard

Test number

| | | |
|---|---|---|
| 60 | 61 | 62 |

Description

| | | Pectin + | Pectin + |
|---|---|---|---|
| | | encapsulated | calcium |
| Ingredients | Control | calcium | sulphate |
| water | 71.51 | 67.88 | 70.68 |
| Skimmed milk | 13.25 | 13.25 | 13.25 |
| powder | | | |
| starch | 5.69 | 5.69 | 5.69 |
| Icing sugar | 8.55 | 8.55 | 8.55 |
| Alginate control | 1 | | |
| (Gelcarine FF 48) | | | |
| sucrose | | 0.54 | 0.54 |
| Pectin | | 0.96 | 0.96 |
| Encapsulated | | 3 | |
| calcium lactate | | | |
| Calcium sulphate | | | 0.2 |
| enzyme | | 0.13 | 0.13 |

Procedure: All dry ingredients were premixed. Cold water was added to a Thermomix, for sample 61 and 62, enzyme was also added.

The dry mix was added to the Thermomix and mixed for 3 min at speed 4 with reversed knives.

The final mix was put in cans and stored cold.

TABLE 18
Results from experimental work (Examples 60-62). Gel strengths
measured at 5° C. (area under the curve) with a 0.5 inch
probe. Texture was measured after overnight storage at 5° C.

| | Test number | | |
|---|---|---|---|
| | | 61 | 62 |
| | | Pectin + | Pectin + |
| | 60 | encapsulated | calcium |
| | Control | calcium | sulphate |
| Texture | 1591 ± 23 | 3717 ± 8 | 2931 ± 51 |
| pH | 6.67 | 5.95 | 6.01 |

After 1.5 hours all the samples had gelled and could be cut with a knife. A piece with dimensions of 5×3×1.5 cm was cut and placed on a baking sheet to test for heat stability. The samples were baked for 10 minutes in a preheated oven set to 200° C. All samples withstood the heating test.

### CONCLUSIONS ON RESULTS

The present invention shows the possibility for making strong LM-pectin-type gels at fridge temperatures (5° C.) without any hot pre-solubilization of the HM-pectin sources, being either HM-pectin or a citrus fiber containing HM pectin, simply by adding a methylesterase and a calcium source.

This new, unique technique can be considered in applications typically being gelled with alginate and/or LM pectin systems. This technique offers unique advantages in terms of strength and clean labelling, when applied in the plant-based meat alternative field, as demonstrated in the experimental section. A combination of alginate, HM pectin source and methylesterase creates additional strength compared to alginate alone as demonstrated in trial 4 and 5.

Furthermore, the in-situ generated LM-pectin created according to this invention provide stronger gels than when the same concentrations of commercial LM-pectins are used, as demonstrated in trial 9 and 10 compared to trial 1.

The application discloses the following numbered clauses:
1. A process for producing a gel composition comprising the steps of:
   a. preparing a gelling composition by hydrating the blend of a calcium source, and a pectin source without a hot pre-solubilization and methylesterase, the methylesterase either being added separately as a liquid preparation to the water or included in the dry-blend, when a lyophilized preparation is used,
   b. adding 0-75% of a protein fraction, such as being hydrated textured proteins or a protein isolate or a protein concentrate for a plant-based meat-alternative product, or animal-based protein
   c. leaving the mixture for gelling
2. The process of clause 1, wherein the gelling mixture is kept at refrigeration temperature for at least 30 minutes.
3. The process of clause 1, wherein the gelling mixture is kept at the optimum temperature for the methylesterase.
4. The process of any of the preceding clauses, wherein the methylesterase is added separately as a liquid preparation to the water.
5. The process of any of the preceding clauses, wherein the methylesterase is included in the dry-blend.
6. The process of any of the preceding clauses, wherein the methylesterase is used as a lyophilized preparation.
7. The process of any of the preceding clauses, wherein the above gelling composition is mixed with plant-based proteins and/or animal-based proteins.
8. The process of any of the preceding clauses, wherein the animal-based protein is mechanical deboned meat.
9. The process of any of the preceding clauses, wherein the gelling composition is mixed into a fruit-based system.
10. The process of any of the preceding clauses, wherein the calcium source is a sparingly soluble calcium source, a coated or encapsulated calcium source.
11. The process of any of the preceding clauses, in which the plant-based protein is selected from isolated soy, texturized soy protein, pea protein, wheat, canola, potato, rapeseed or combinations thereof.
12. The process of any of the preceding clauses, in which the plant based protein is preferably isolated or texturized soy or pea protein.
13. The process of any of the preceding clauses, in which the plant-based protein concentration is between 0-25% by weight of the gel
14. The process of any of the preceding clauses in which the calcium source is selected from the group of calcium alginate, calcium sulphate, calcium chloride, calcium acetate, calcium carbonate, di-calcium phosphate and encapsulated calcium lactate.
15. The process of any of the preceding clauses, wherein the calcium source is encapsulated calcium lactate.
16. The process of any of the preceding clauses, in which the pectin source is preferably isolated HM pectin or citrus peel.
17. The process of any of the preceding clauses, in which the Pectin source is present in an amount of 0.5-10% by weight of the obtained gel.
18. The process of any of the preceding clauses, wherein alginate is present.
19. The process of any of the preceding clauses, in which the calcium source is delivering an amount of calcium corresponding to 0.05-20% of the pectin source and/or alginate content.
20. The process of any of the preceding clauses, in which the calcium source is preferably encapsulated calcium lactate, present from a fourth (w/w) the amount of the pectin source and/or alginate content to four times the amount of the pectin source and/or alginate content.
21. The process of clause 20, in which the encapsulated calcium lactate is present in an amount of 0.5-8% by weight of the obtained gel.
22. The process of any of the preceding clauses, in which the gelling composition has a final pH of 2-7, optionally 3-7.
23. The process of any of the preceding clauses, wherein the gelling composition has a final pH of about 5.8.
24. The process of any of the preceding clauses, wherein alginate is present in a 1:1 ratio with HM pectin.
25. A process for obtaining a plant-based food product, wherein the gelling composition as described in clauses 1 to 24 is added and mixed into the final food product mixture prior to forming the finished uncooked food product.
26. A process for obtaining a plant-based food product comprising the steps of combining the minced gels obtained by the process described in any of the preceding clauses with additional plant-based protein isolates, that would gel during cooking.
27. The product obtained by the use of a process as described in any of the preceding clauses.
28. The gelling composition for a cold process as described in clauses 1-27, comprising
   a) Pectin source and/or alginate source
   b) Methylesterase
   c) Calcium source
29. The gelling composition of any of the clauses above, wherein the gelling composition is provided as a dry powder.

1. A process for producing a gel composition under cold process conditions of temperatures from above 0 degrees Celsius to below 20 degrees Celsius, comprising:
adding a calcium source, a pectin source and methylesterase to 0-75% of fruit, vegetable or hydrated textured proteins or an animal-based raw material, and
stuffing or forming a cold mixture and leaving the cold mixture for gelling.

2. The process of claim 1, wherein the methylesterase is added as a powder or liquid preparation.

3. The process of claim 1, wherein the calcium source, the pectin source and the methylesterase are added as a dry blend in powder form and added to a cold liquid preparation of vegetable origin and further mixing with the 0-75% of the hydrated textured proteins, and the cold liquid preparation of vegetable origin is based on plant-based proteins selected from isolated or concentrated soy protein, isolated or concentrated pea protein, wheat, canola, potato, rapeseed, or combinations thereof.

4. The process of claim 1, wherein the calcium source, the pectin source and the methylesterase are added as a dry blend in powder form and added to a cold liquid preparation of vegetable origin and the cold liquid preparation of vegetable origin is based on fruits.

5. The process of claim 1, wherein the gelling mixture is kept at refrigeration temperature for 0.5-10 hours before the gelling mixture is further processed, being cut, packed and frozen or cooked.

6. The process of claim 1, wherein the gelling mixture is kept at optimum temperature for the methylesterase for 0.5-2 hours before the gelling mixture is further processed, being cut, packed and frozen or cooked.

7. The process of claim 1, wherein the calcium source is a sparingly soluble calcium source or a coated or encapsulated calcium source.

8. The process of claim 1, wherein the hydrated texture proteins are used, and the plant-based protein concentration is between 0-25% by weight of the gel.

9. The process of claim 1, in which the calcium source is selected from the group of calcium sulphate, calcium citrate, calcium carbonate, di-calcium phosphate and encapsulated calcium lactate.

10. The process of claim 1, wherein the calcium source is encapsulated calcium lactate.

11. The process of claim 1, in which the pectin source is isolated high methoxyl pectin or other sources containing high methoxyl pectin.

12. The process of claim 1, in which the pectin source is present in an amount of 0.5-10% by weight of the obtained gel.

13. The process of claim 1, wherein the pectin source is high methoxyl pectin and alginate is present together with the high methoxyl pectin.

14. The process of claim 1, in which the calcium source is delivering an amount of calcium corresponding to 0.05-20% of the pectin source and alginate content.

15. The process of claim 1, in which the calcium source is encapsulated calcium lactate, present from a fourth (w/w) the amount of the pectin source and alginate content to four times the amount of the pectin source and alginate content.

16. The process of claim 1, in which the gel composition has a final pH of 2-7.
